(19) United States
(12) Patent Application Publication
(10) Pub. No.: US 2010/0164422 A1
(43) Pub. Date: Jul. 1, 2010

(54) VARIABLE MAGNETIC FLUX ELECTRIC ROTARY MACHINE

(75) Inventors: Kohin SHU, Hitachi (JP); Taizo MIYAZAKI, Hitachi (JP); Houng Joong KIM, Mito (JP); Satoru OKABE, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/645,854

(22) Filed: Dec. 23, 2009

(30) Foreign Application Priority Data
Dec. 26, 2008 (JP) 2008-331833

(51) Int. Cl. H02K 23/44; H02P 7/298

(52) U.S. Cl. 318/540; 310/126; 903/906

(57) ABSTRACT

An electric rotary machine is disclosed which can adjust relative angles of sub-rotors continuously and regardless of torque direction without generating an attractive force between the field magnets of the sub-rotors. The electric rotary machine includes: a stator having a winding; a dual rotor which is rotatably disposed with a gap from the stator and divided axially along a shaft into a first rotor and a second rotor each having field magnets with different polarities arranged alternately in a rotation direction; a mechanism for varying the axial position of the second rotor relative to the first rotor continuously; and a non-magnetic member located between the first rotor and the second rotor.

### CLAIM OF PRIORITY

The present application claims priority from Japanese patent application serial No. 2008-331833 filed on Dec. 26, 2008, the content of which is hereby incorporated by reference into this application

### BACKGROUND OF THE INVENTION

1. Field of the Invention

The present invention relates to electric rotary machines which vary the amount of effective flux mechanically depending on torque and revolution speed, and electrical products, vehicles, mobile devices, wind power generation systems, and transport vehicles using the same.

2. Description of the Related Art

The use of permanent magnet synchronous motors (PM motors) which are excellent in efficiency and can be compact and less noisy has been spreading as an alternative to conventional induction motors (IM motors). For example, PM motors are becoming popular as drive motors for household electric appliances, rail cars, and electric vehicles. IM motors have the following problem: since a magnetic flux is generated by an excitation current from a stator, a loss due to an excitation current flow may occur. On the other hand, PM motors use permanent magnets for rotors and produce a torque using a magnetic flux from the permanent magnets. In other words, PM motors do not have the problem inherent in IM motors because they do not require the use of an excitation current.

However, in PM motors, a permanent magnet generates an induced electromotive force in the armature coil in proportion to the revolution speed. For applications which have a wide revolution speed range such as train cars and vehicles, it is necessary to ensure that an overvoltage due to an induced electromotive force generated at a maximum revolution speed does not cause breakdown of the inverter for controlling the PM motor.

Taking this aspect of PM motors into consideration, the following approach, which is called “magnetic-field weakening control,” is adopted for constant output operation of PM motors with a constant supply voltage: a current to remove the magnetic flux from the permanent magnet is made to flow in the armature coil to decrease the induced electromotive force equivalently as a measure to increase the maximum revolution speed and widen the operation speed range. However, magnetic-field weakening control results in efficiency deterioration because it uses a current not contributory to the torque. Furthermore, a large current should flow in the armature coil with a resulting increase in the heat generated in the coil. This means that the following problems may occur: a decline in the efficiency of the electric rotary machine in a high revolution speed range and demagnetization of the permanent magnet attributable to heat generation beyond the cooling capacity.

With this background, there has been known an electric rotary machine as described in JP-A No. 2001-69609 in which the amount of effective flux is varied mechanically instead of the approach of weakening the magnetic field electrically. The electric rotary machine as described in JP-A No. 2001-69609 uses a rotor which is divided into two half rotors in the shaft (axial) direction and these half rotors (sub-rotors) each have field magnets with different polarities arranged along the rotation (circumferential) direction alternately.

When the electric rotary machine is to function as a motor, the centers of the poles of the field magnets of one half rotor are aligned with those of the other half rotor, according to the magnetic action between the field magnets of one half rotor and those of the other half rotor and the torque direction balance between the half rotors to make the amount of effective flux maximum.

When the machine is to function as a generator, the centers of the filed magnet poles of the half rotors are not aligned as the torque directions of the half rotors become opposite to make the amount of effective flux minimum. The amount of effective flux is mechanically varied by shifting the centers of the magnet poles of the half rotors in this way.

As another electric rotary machine which uses a mechanical flux varying mechanism, JP-A No. 2004-64942 describes an electric rotary machine which includes a mechanism to cushion a shock given to a half rotor or a mechanical flux varying mechanism during flux variation in the half rotor with change in the rotor torque direction, in order to improve the reliability of a carrier in which the machine is mounted, such as a vehicle.

However, these electric rotary machines do not have any means to adjust relative angles of rotors continuously and regardless of the direction of torque. Furthermore, for applications which require a wide range of revolution speed and a wide torque range, such as vehicles, it is effective to broaden the range of effective flux variation. However, in the electric rotary machines using conventional mechanical flux varying mechanisms, when the amount of effective flux is reduced to 50% or less, an attractive force is generated between the field magnets of the two half rotors. For this reason, in order to increase the amount of effective flux while there is such an attractive force, it is necessary to apply a force larger than the attractive force to vary the center angles of the magnet poles of the rotors. This requires a larger rotor angle adjusting mechanism. In the worst case, the net attractive force may cause the two rotors to stick together, making it impossible to proceed to the next flux variation stage.

An object of the present invention is to provide an electric rotary machine which can adjust relative angles between sub-rotors continuously and regardless of torque direction without generating an attractive force between the field magnets of the sub-rotors.

### SUMMARY OF THE INVENTION

In order to solve the above problem, according to one aspect of the invention, there is provided an electric rotary machine which includes a stator having a winding, a dual rotor which is rotatably disposed with a gap from the stator and divided axially along a shaft into a first rotor and a second rotor each having field magnets with different polarities arranged alternately in a rotation direction, a mechanism for varying an axial position of the second rotor relative to the first rotor continuously, and a non-magnetic member located between the first rotor and the second rotor.

According to a second aspect of the invention, there is provided an electric rotary machine which includes a stator having a winding, a rotor which is rotatably disposed with a gap from the stator and divided axially along a shaft into a first rotor, a second rotor and a third rotor each having field magnets with different polarities arranged alternately in a rotation direction, and a mechanism for varying axial positions of the second rotor and the third rotor relative to the first rotor continuously.

According to a third aspect of the invention, there is provided an electric rotary machine which includes a stator having a winding, a rotor which is rotatably disposed with a gap from the stator and divided axially along a shaft into four or more rotors each having field magnets with different polarities arranged alternately in a rotation direction, and a control mechanism for controlling rotation of each rotor.

According to the present invention, highly efficient operation in a wide operation speed range can be achieved by mechanically varying the effective flux of an electric rotary machine for magnetic fields. For a motor-generator type electric rotary machine, efficiency can be improved by varying the effective flux depending on revolution speed and torque. Furthermore, according to the invention, in mobile devices such as vehicles, an electric rotary machine can achieve a large torque at low revolution speed and a large output at high revolution speed. In particular, an electric rotary machine according to the invention is useful for vehicles and wind power generation systems which involve large load variations.

### BRIEF DESCRIPTION OF THE DRAWINGS

FIG. 1A shows the structure of an electric rotary machine according to a first embodiment of the invention;

FIG. 1B shows the side view of FIG. 1A;

FIGS. 2A to 2C illustrate how the rotors of the electric rotary machine shown in FIG. 1 are activated, in which FIG. 2A shows a stage to maximize the effective flux, FIG. 2B shows a stage to decrease the effective flux, and FIG. 2C shows a stage to minimize the effective flux;

FIGS. 3A to 3C illustrate how the rotors of an electric rotary machine according to a second embodiment are activated, in which FIG. 3A shows a stage to maximize the effective flux, FIG. 3B shows a stage to decrease the effective flux, and FIG. 3C shows a stage to minimize the effective flux;

FIGS. 4A to 4C illustrate how a one-touch structure works, in which FIG. 4A shows a bayonet bar before being inserted into the body, FIG. 4B shows the bar in the locked state, and FIG. 4C shows how the bar is unlocked;

FIGS. 5A to 5F illustrate an example of application of the one-touch structure to the rotors, in which FIG. 5A to 5C show how to lock and unlock a second rotor and a third rotor and FIG. 5D to 5F show how to move the second rotor to weaken the effective flux;

FIG. 6 shows an electric rotary machine having a rotor equally divided into three sub-rotors;

FIG. 7 shows how a mechanism according to a third embodiment works;

FIGS. 8A to 8F illustrate how the rotors in an electric rotary machine using the mechanism shown in FIG. 7 are activated, in which FIG. 8A to BC show that the third and second rotors move together and FIG. 8D to 8F show that only the second rotor moves to weaken the effective flux;

FIG. 9 shows the structure of an electric rotary machine with four or more sub-rotors;

FIGS. 10A to 10D illustrate a two-way clutch structure, in which FIG. 10A shows components of the structure, FIG. 10B shows a positional relation between a roller and an outer ring, FIG. 10C shows another positional relation between them and FIG. 10D shows a third positional relation between them;

FIG. 11 shows the configuration of a drive system of a hybrid electric vehicle according to a fifth embodiment; and

FIG. 12 shows the configuration of a drive system of a hybrid electric vehicle according to a sixth embodiment.

### DETAILED DESCRIPTION OF THE PREFERRED EMBODIMENTS

Next, the preferred embodiments of the present invention will be described in detail referring to the accompanying drawings.

### First Embodiment

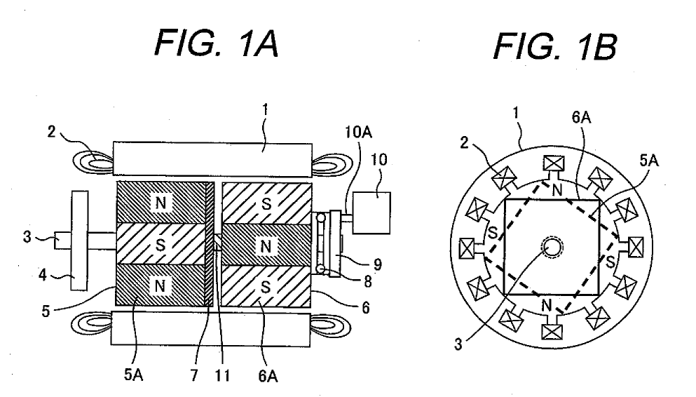

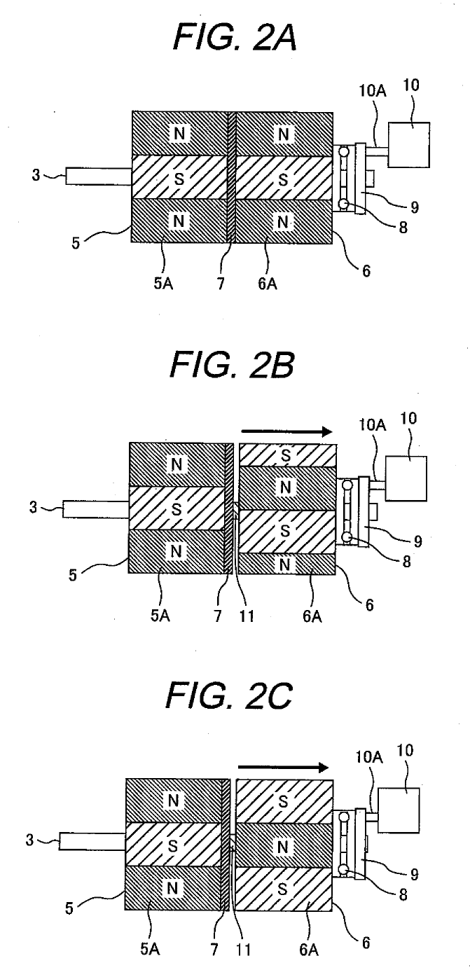

The first embodiment is described below referring to FIG. 1 and FIG. 2A to FIG. 2C.

FIG. 1 shows the structure of an electric rotary machine according to the first embodiment. As shown in FIG. 1, a plurality of open-ended slots (also called grooves) are axially continuously formed in the inner surface of a cylindrical stator core 1 in the rotation direction, with an armature winding 2 (also called a stator winding or primary winding) fitted in each of the slots. The outer side of the stator core 1 is fastened to a housing (not shown) by shrink fitting or press fitting and an end thereof in the axial direction is covered by a bracket 4.

A rotor is rotatably disposed inside the stator core 1 with a gap from it. The rotor is axially divided into two half rotors which are a first rotor 5 fixed on a shaft 3 and a second rotor 6 which can move axially along the shaft while rotating on a spline 11 provided in the shaft 3. The second rotor 6 provides a spline hole engaged with the spline 11.

A plurality of permanent magnet 5A is embedded in the first rotor 5 in a way that their polarities alternate in the rotation (circumferential) direction of rotation. Also, a plurality of permanent magnet 6A is embedded in the second rotor 6 in a way that their polarities alternate in the rotation direction. Both ends of the shaft 3 in the center axis direction are rotatably supported by bearing devices (not shown).

A non-magnetic material 7 is fixed on the shaft between the first rotor 5 and second rotor 6 in the same way as the first rotor 5. In this embodiment, the non-magnetic material 7 is located on the side face of the first rotor facing the second rotor. Also, a support mechanism for supporting the second rotor and controlling its axial position is provided.

This support mechanism includes a bearing 8, a stopper 9, and an actuator 10. The support mechanism can move the second rotor to a given position through the bearing 8 and stopper 9 by moving a movable part 10A of the actuator 10. A stepping motor can be used for the actuator 10.

In this embodiment, the second rotor is activated depending on torque and revolution speed, as illustrated in FIG. 2A to 2C. More specifically, in this embodiment, there are three stages shown in FIG. 2A to FIG. 2C.

In the stage of FIG. 2A, in which the effective flux should be maximized, the first rotor 5 and second rotor 6 are brought closer and united and the permanent magnets 5A and 6A with the same polarity are arranged in line axially and their pole centers are aligned. Here, the support mechanism supports the second rotor 6 on the opposite side of the first rotor 5. Specifically, according to an actuator control signal, the movable part 10A moves the second rotor to a given position through the bearing 8 and stopper 9.

FIG. 2B shows a stage in which the amount of effective flux is smaller than in the stage of FIG. 2A. In this stage, the second rotor 6 is moved in one axial direction (direction opposite to the first rotor 5) away from the first rotor 5 and brought to a given position while rotating on the shaft 3.

In the stage of FIG. 2C, the axial position of the second rotor 6 relative to the first rotor 5 is such that the combined magnetic field value of the permanent magnets 5A and 6A is zero and the distance of the second rotor 6 from the first rotor 5 is maximized by the support mechanism. In this stage, the amount of effective flux for magnetic fields is zero and the back electromotive force is zero. The feature that the amount of effective flux becomes zero can be used to protect the electric rotary machine.

The axial position of the second rotor 6 is controlled by controlling the amount of movement of the movable part 10A of the actuator according to an actuator control signal and letting the movable part 10A move the second rotor to a given position through the bearing 8 and stopper 9. By controlling the axial position of the second rotor 6 in this way, the rotation angle of the second rotor is varied to vary the amount of effective flux.

The spline 11 is used to control the horizontal movement distance to vary the rotation angle. The movement distance and relative rotation angle are varied by changing the pressure angle and helical angle of the spline. For example, when the helical angle is doubled, the relative rotation angle is doubled with the same movement distance. In addition, since the shaft can be either left splined or right splined (in this embodiment, left splined for the left first rotor 5 and right second rotor 6), it is easy to optimize the spline design for each application. A ball screw mechanism can be used instead of the spline mechanism.

The non-magnetic material 7 has a property that its influence on a magnetic field is minimum and there is no remnant magnetism after it leaves the magnetic field. For example, the material may be aluminum, copper, SUS 304 stainless steel, NiCrAL alloy or the like. Although a space, namely an air layer, may be used instead of such a material, for the purpose of compactness of the machine or reduction of the influence of remnant magnetism it is more desirable to use a non-magnetic material 7 which shuts off magnetism more effectively than an air layer. Regarding the location of the non-magnetic material 7, it should lie between the first rotor 5 and second rotor 6 and it may be fitted to a surface of either the first rotor or the second rotor or independently installed between the first rotor 5 and second rotor 6.

In this embodiment, the pulse signal from the drive for the actuator 10 is controlled to control the axial position of the stopper 9 freely by the pushing force of the actuator movable part (for forward movement of the movable part 10A) and its pulling force (for backward movement of the movable part 10A). Therefore, the axial position of the second rotor 6 with respect to the first rotor 5 can be varied freely.

In this embodiment, the effective flux can be varied easily through transition from the stage of FIG. 2A to the stage of FIG. 2C by control of the actuator regardless of the torque direction of the electric rotary machine. The efficiency can be improved by varying the effective flux depending on revolution speed and torque. In addition, since no shock is given to the support mechanism, the burden on the support mechanism is reduced and reliability is improved. Furthermore, the presence of the non-magnetic material 7 between the first rotor 5 and second rotor 6 suppresses the attractive force generated between field magnets and permits smooth variation of effective flux.

Although the drive system for the support mechanism uses a combination of a stepping motor and a ball screw in this embodiment, instead a combination of a solenoid and a spring for driving the movable core electromagnetically or a hydraulic actuator or linear motor may be used. Thus, since it is enough to provide a servo mechanism capable of position control as mentioned above, this embodiment is easy to realize.

### Second Embodiment

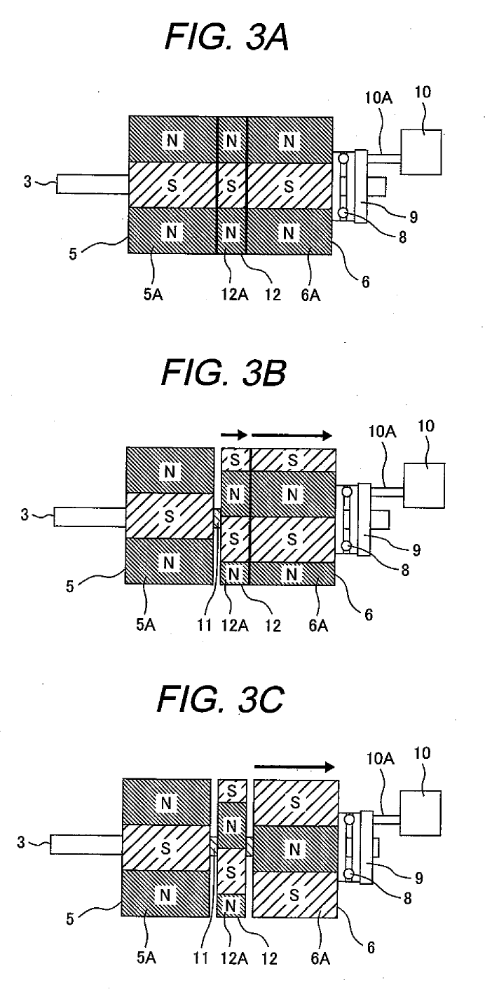

The second embodiment is described below referring to FIG. 3A to FIG. 3C. In the description below, the same components as used in the first embodiment are designated by the same reference numerals and their description is omitted and only the components different from those in the first embodiment are described.

This embodiment concerns an electric rotary machine which has a third rotor 12 between the first rotor 5 and second rotor 6, as illustrated in FIGS. 3A to 3C. In this electric rotary machine, the second rotor 6 and third rotor 12 are activated depending on torque and revolution speed, as shown in FIG. 3A to 3C. More specifically, in this embodiment, there are three stages in which the second rotor 6 and third rotor 12 move axially on the spline 11 as shown in FIG. 3A to FIG. 3C.

In the stage of FIG. 3A, in which the effective flux should be maximized, the first rotor 5, third rotor 12 and second rotor 6 are brought closer and united and the permanent magnets 5A, 12A and 6A with the same polarity are arranged in line axially and their pole centers are aligned. Here, the support mechanism supports the second rotor 6 on the opposite side of the third rotor 12 to control the axial positions of the rotors. Specifically, according to an actuator control signal, the amount of movement of the movable part 10A is controlled so that the movable part 10A moves the second rotor and third rotor to their respective given positions through the bearing 8 and stopper 9.

Next, how the effective flux is varied in this embodiment is explained. As illustrated in FIG. 3B, after the stage of FIG. 3A, the third rotor 12 and second rotor 6 are moved together and stopped when the pole centers (N or S pole centers) of the permanent magnets 12A of the third rotor 12 are deviated from the pole centers of the permanent magnets 5A of the first rotor by half of the mechanical angle of each magnet. In this stage, the magnetic attractive force and repulsive force between the first rotor 5 and third rotor 12 are balanced. For example, if each rotor has eight permanent magnets, the mechanical angle of each permanent magnet is 45 degrees and the magnet pole center angle is 22.5 degrees.

Then, after the stage of FIG. 3B, only the second rotor 6 moves while rotating until the polarities of the pole centers of the permanent magnets of the second rotor 6 are opposite to those of the first rotor 5, as illustrated in FIG. 3C. In this stage, the third rotor 12 is fixed in a position as shown in FIG. 3B by the stopper fixed on the shaft 3. The stopper fixed on the shaft 3 is housed in a dent of the second rotor 6 in the stage of FIG. 3A. In the stage of FIG. 3B after the second rotor 6 and third rotor 12 move axially, the stopper is brought into contact with the third rotor 12 and the third rotor 12 is fixed by the stopper.

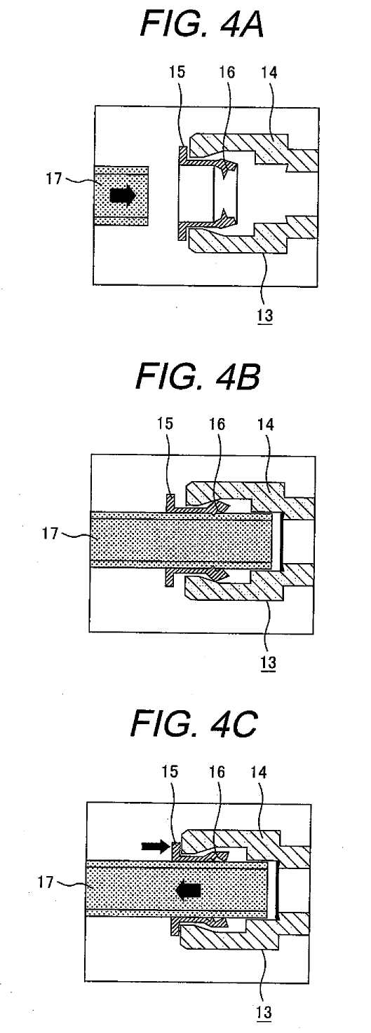

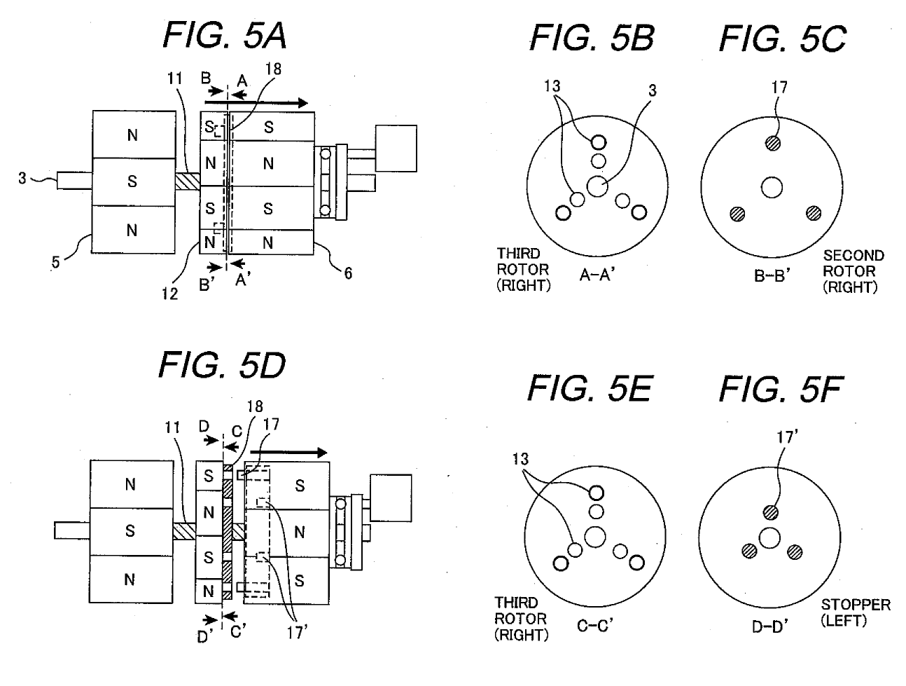

Next, an example of the mechanism for achieving the sequence shown in FIGS. 3A to 3C will be explained referring to FIGS. 4A to 4C and FIGS. 5A and 5B. The one-touch structure 13 shown in FIGS. 4A to 4C includes a body 14, collet 15 and grip 16. The procedure from the step of FIG. 4A to the step of FIG. 4C can be repeated.

As illustrated in FIG. 4A and FIG. 45, when the bayonet bar 17 is inserted into the body 14 of the one-touch structure 13, the bayonet bar 17 is locked by the grip 16. Consequently the body 14 and bayonet bar 17 are fixed. To remove the bayonet bar 17 from the body 14, the bar 17 is unlocked by pushing the collet 15 as shown in FIG. 4C and can be pulled out while the collet 15 is held pushed.

An example of application of this one-touch structure to the second rotor 6 and third rotor 12 is explained below. The second rotor 6 has the bayonet bar 17 and, as shown in FIG. 5B, the third rotor 12 has the one-touch structure 13 which provides the body 14, collets 15 and grips 16.

The second rotor 6 and third rotor 12, thus constituting a one-touch structure 13, work as follows. First, as shown in FIG. 5A, the second rotor and third rotor are locked by the one-touch structure (FIG. 4B) and moved together away from the first rotor while rotating until they are rotated by half of the mechanical angle of each magnet. When they have rotated by half of the mechanical angle, the third rotor 12 is fixed on the shaft 3 and stopped by the stopper 18. The stopper 18, as shown in FIG. 5F, has members 17′ for pushing the collets 15 of the third rotor 12. With the stopper 18 in contact with the third rotor 12, the members 17′ of the stopper 18 push the collets 15 of the third rotor 12 to unlock the one-touch structure 13 between the second rotor 6 and third rotor 12.

After that, as shown in FIG. 5B, the second rotor moves independently while rotating until the pole centers of the first rotor 5 are aligned with the pole centers of the second rotor 6 with reverse polarities to weaken the effective flux. When this process is reversed, the effective flux is strengthened.

In this embodiment, due to the presence of the third rotor between the first rotor and second rotor, when the effective flux is zero, the attractive force and repulsive force of the permanent magnets between the first rotor and third rotor and between the third rotor and second rotor are balanced so that a next action for varying the magnetic flux can be carried out smoothly with no additional load on the support mechanism. This means that the amount of effective flux for magnetic fields can be varied from zero to the maximum without such a non-magnetic material as used in the first embodiment.

In this embodiment, the axial length of each rotor is not limited but preferably the axial length ratio of the first rotor to the second rotor is 1:1.

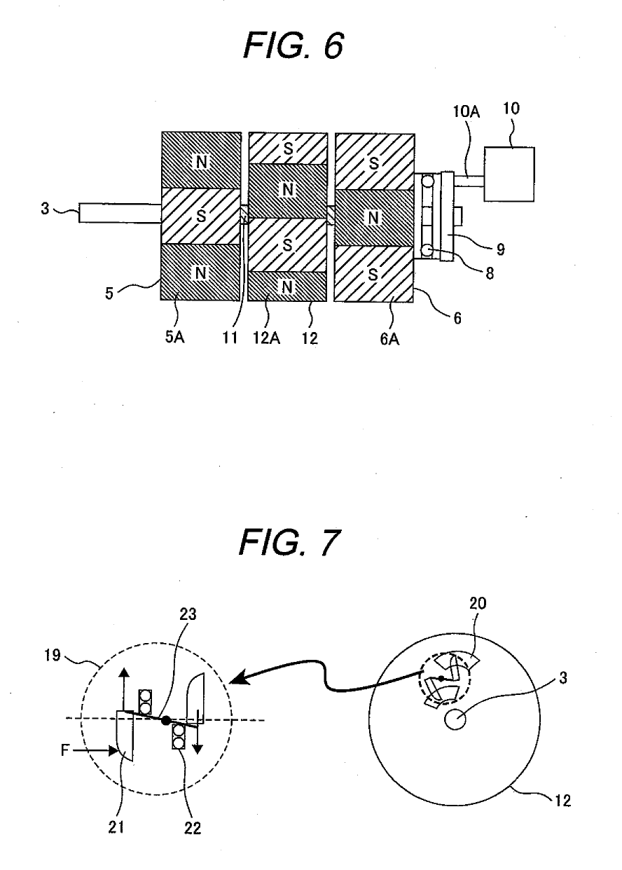

Furthermore, preferably the triple rotor is equally divided into three sub-rotors as shown in FIG. 6. In other words, the axial length ratio of the three sub-rotors, the first, second and third rotors, should be 1:1:1. The use of the sub-rotors of the same axial length makes magnetic balancing easy.

In this embodiment, the effective flux can be easily adjusted by control of the actuator regardless of the torque direction of the electric rotary machine. The efficiency can be improved by varying the effective flux depending on revolution speed and torque. In addition, since no shock is given to the support mechanism, the load on the support mechanism is reduced and reliability is improved.

### Third Embodiment

The third embodiment concerns an improvement in the mechanism for rotation of the second and third rotors relative to the first rotor in the second embodiment. In the description below, the same components as used in the foregoing embodiments are designated by the same reference numerals and their description is omitted and only the components different from those in the foregoing embodiments are described.

As shown in FIG. 7, the third embodiment uses a flux varying mechanism which includes an interlock means 19 and grooves 20 both located in the third rotor 12 to activate the second rotor and third rotor according to the second embodiment. This mechanism is so designed that by applying a force to one movable wedge 21 laterally, an interlock holder 23 with springs 22 moves the other movable wedge similarly.

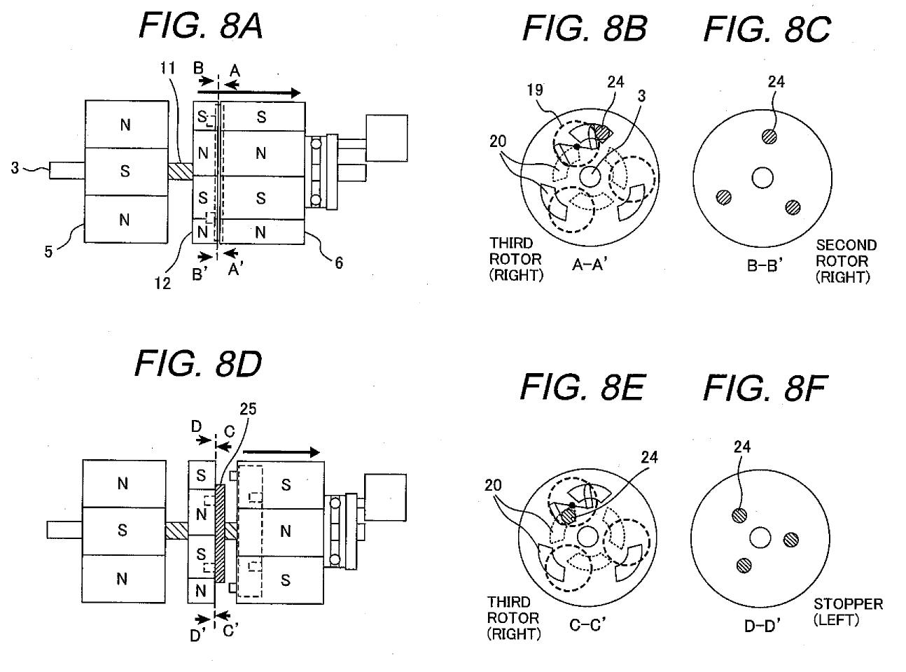

How the second rotor 6 and third rotor 13 are activated is described below referring to FIGS. 8A to 8F. As shown in FIGS. 8A to 8C, projections 24 of the second rotor 6 are locked by the interlock means 19 of the third rotor 12 and the second rotor 6 and third rotor 12 are moved together away from the first rotor while rotating until they rotate by half of the mechanical angle of each magnet.

In FIGS. 8D to 8F, as soon as they have rotated by half of the mechanical angle, the third rotor 12 is stopped by a stopper 25 fixed on the shaft 3 through the interlock means 19 and at the same time the structure between the second rotor 6 and third rotor 12 is unlocked. After that, as shown in FIG. 8D, the second rotor moves independently while rotating until the pole centers of the first rotor are aligned with the pole centers of the second rotor 6 with reverse polarities to weaken the effective flux. When the above process is reversed, the effective flux is strengthened.

In this embodiment, due to the use of the triple rotor as in the second embodiment, when the effective flux is zero, the attractive force and repulsive force of the permanent magnets between the first rotor and third rotor and between the third rotor and second rotor are balanced so that a next action for varying the magnetic flux can be carried out smoothly with no additional load on the support mechanism. This means that the amount of effective flux for magnetic fields can be varied from zero to the maximum without such a non-magnetic material as used in the first embodiment.

### Fourth Embodiment

The fourth embodiment concerns an example of an electric rotary machine using a rotor which is divided into four or more sub-rotors along the shaft, in which each sub-rotor has field magnets with different polarities arranged alternately in the circumferential (rotation) direction.

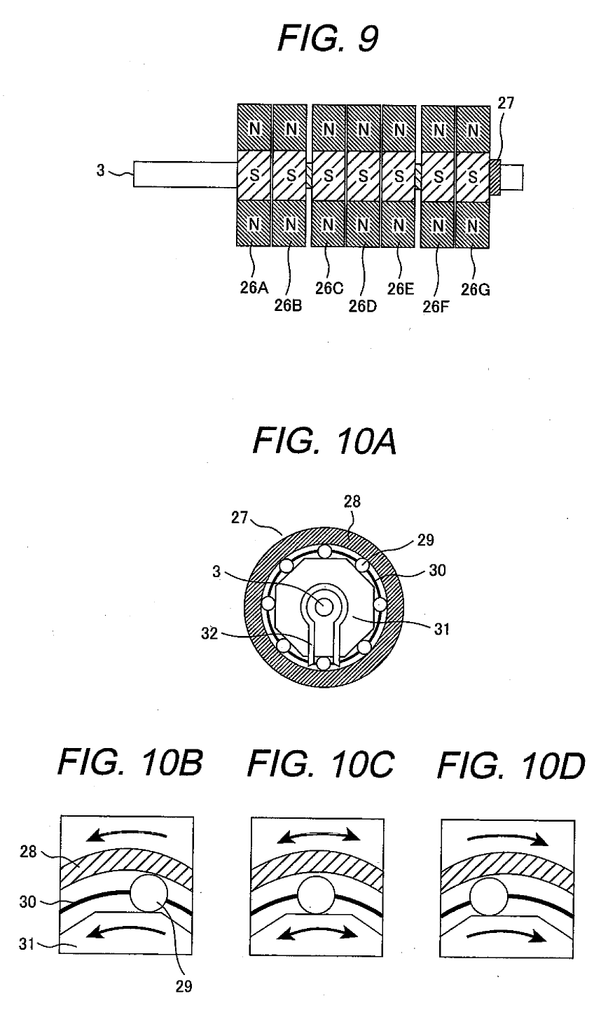

FIG. 9 illustrates an electric rotary machine with a rotor structure having seven sub-rotors, as an example. Arranged in line axially, rotors 26A to 26G (sub-rotors), each having field magnets with different polarities arranged alternately in the rotation direction, are attached to the shaft 3 through a two-way clutch.

As shown in FIG. 10A, the two-way clutch includes an output outer ring 28, rollers 29, a holder 30, an input shaft 31 (called “cam”), and a switch spring 32. The holder 30 and rollers 29 can be moved by controlling the switch spring 32 through an electromagnetic switch (not shown) so that the position of each roller 29 can be controlled as shown in FIGS. 10B to 10D. When the roller 29 is in the position as shown in FIG. 10B or 10D, the output outer ring 28 can rotate in conjunction with rotation of the shaft 3 and when it is in the position as shown in FIG. 10C, power of the shaft 3 is not transmitted to the output outer ring 28 and the ring 28 does not rotate.

In this embodiment, the effective flux for magnetic fields is varied to 0, 1/7, 2/7, 3/7, 4/7, 5/7, 6/7 of the maximum flux, or 1 (maximum flux), according as whether or not each of the rotors 26A to 26G is rotated in conjunction with rotation of the shaft. In other words, the speed can be varied in eight steps. Since an attractive force or repulsive force of field magnets is generated between neighboring rotors (26A to 26G), it is desirable to install a non-magnetic material between rotors in order to avoid an influence of adjacent permanent magnets.

Although the rotor is divided into seven sub-rotors in this embodiment, the invention is not limited thereto. Under the same principle, it may be divided into any number of sub-rotors. The efficiency can be improved by varying the amount of effective flux depending on revolution speed and torque.

### Fifth Embodiment

The fifth embodiment concerns an example of application of an electric rotary machine as proposed by the present invention to a drive system of a hybrid electric vehicle.

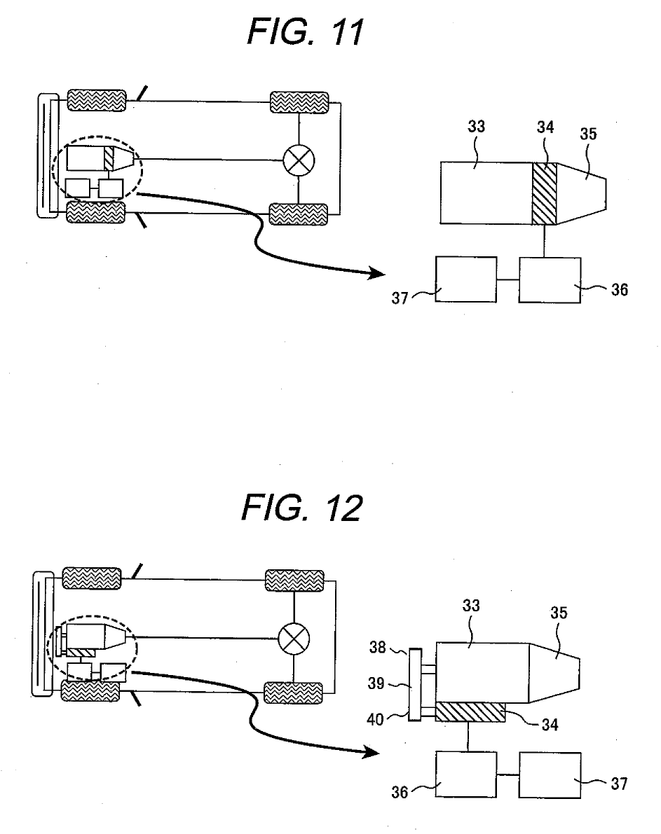

FIG. 11 shows the configuration of a drive system of a hybrid electric vehicle. The drive system includes an internal combustion engine 33 which generates power to drive the vehicle and a transmission 35 as a vehicle speed change mechanism, in which a permanent magnet synchronous electric rotary machine 34 is located between them and mechanically connected with them. The electric rotary machine is an electric rotary machine according to the first, second, third or fourth embodiment.

For connection of the engine 33 and electric rotary machine 34, either of the following methods is adopted: direct connection of the output shaft (not shown) of the engine 33 and the shaft of the electric rotary machine 34, and the use of a reduction gear mechanism such as a planetary gear speed reduction mechanism. Since the electric rotary machine 34 functions as a motor or generator, it is electrically connected with a battery 37 as a storage means through an inverter 36 as a power converter.

When the electric rotary machine 34 is used as a motor, the inverter 36 converts DC power from the battery 37 into AC power which is then supplied to the electric rotary machine 34. The electric rotary machine 34 is thus driven. The driving power of the electric rotary machine 34 is used to start or assist the engine 33.

When the electric rotary machine 34 is used as a generator, the inverter 36 (converter function) converts AC power generated by the electric rotary machine 34 into DC power which is supplied to the battery 37. The converted DC power is thus stored in the battery 37.

In conventional permanent magnet synchronous electric rotary machines, the back electromotive force of magnets increases with rise in the revolution speed, so there is difficulty in driving the machine in a high revolution speed range due to the restrictions of the battery and inverter. In order to help drive the electric rotary machine in a high revolution speed range, magnetic field weakening control may be used in which the flux from permanent magnets is equivalently weakened by an electric current; however, the use of a current not contributory to the torque results in efficiency deterioration. On the other hand, a variable magnetic flux electric rotary machine according to the present invention mechanically generates an optimum effective flux for magnetic fields depending on revolution speed and torque. Thus the restrictions of the battery and inverter due to the back electromotive force are eased and thanks to the absence of a current not contributory to the torque, the efficiency is improved.

According to the fifth embodiment, when the electric rotary machine in the present invention is adopted, the required withstand voltage is decreased and the required inverter capacity is reduced. This can lead to a lower inverter cost and a smaller inverter size. In addition, the variable magnetic flux electric rotary machine in the present invention can operate in a wide revolution speed range with high efficiency, so reduction in the number of shift gear stages or omission of shift gears may be possible. Therefore, the whole drive system may be more compact.

### Sixth Embodiment

The sixth embodiment concerns an example of application of an electric rotary machine as proposed by the present invention to a drive system of a hybrid electric vehicle.

FIG. 12 shows the configuration of a drive system of a vehicle in which an electric rotary machine according to the first, second, third or fourth embodiment is mounted. The drive system includes a crank pulley 38 for an engine 33 and a pulley 40 connected with the shaft of the electric rotary machine 34, which are connected by a metal belt 39. Therefore, the engine 33 and the electric rotary machine 34 are arranged side by side. In this example of the vehicle drive system, the electric rotary machine 34 can function as a motor or a generator or a motor-generator.

In this embodiment, the crank pulley 38, metal belt 39 and pulley 40 can constitute a speed change (gear shift) mechanism with a certain speed ratio between the engine 33 and the electric rotary machine 34. For example, if the radius ratio between the crank pulley 38 and pulley 40 is 2:1, the electric rotary machine 34 can rotate at a speed twice as high as the speed of the engine 33 and at the start of the engine 33, the torque of the electric rotary machine 34 can be one half of the torque required to start the engine 33. This means that the electric rotary machine 34 can be smaller in size.

Examples of vehicles which use an electric rotary machine according to the first, second, third or fourth embodiment are listed below.

One example is a vehicle which includes: an internal combustion engine which drives wheels; a battery which charges or discharges power; a motor-generator which is mechanically connected with the crankshaft of the internal combustion engine, driven by power supplied from the battery to drive the engine, and powered by the engine to generate power and supply the generated power to the battery; a power converter which controls power supplied to the motor-generator and power supplied from the motor-generator; and a controller which controls the power converter, in which the motor-generator is an electric rotary machine according to the first, second, third or fourth embodiment. This vehicle is an ordinary vehicle which uses an internal combustion engine to drive the wheels or a hybrid electric vehicle which uses an internal combustion engine and a motor-generator to drive the wheels.

A second example is a vehicle which includes: an internal combustion engine which drives wheels; a battery which charges or discharges power; a motor-generator which is driven by power supplied from the battery to drive the wheels and receives a driving force from the wheels to generate power and supplies the generated power to the battery; a power converter which controls power supplied to the motor-generator and power supplied from the motor-generator; and a controller which controls the power converter, in which the motor-generator is an electric rotary machine according to the first, second, third or fourth embodiment. This vehicle is a hybrid electric vehicle which uses an internal combustion engine and a motor-generator to drive the wheels.

A third example is a vehicle which includes: a battery which charges or discharges power; a motor-generator which is driven by power supplied from the battery to drive the wheels and receives a driving force from the wheels to generate power and supplies the generated power to the battery; a power converter which controls power supplied to the motor-generator and power supplied from the motor-generator; and a controller which controls the power converter, in which the motor-generator is an electric rotary machine according to the first, second, third or fourth embodiment. This vehicle is an electric vehicle which uses an electric rotary machine to drive the wheels.

### Seventh Embodiment

The seventh embodiment concerns an example of application of an electric rotary machine as proposed by the present invention to a washing machine.

The conventional technique of washing machines has a problem that when the torque of the motor is transmitted through a pulley using a belt and a gear, a considerable level of sliding or hitting noise is generated between the belt and gear. For a direct-drive type washing machine in which the torque of the motor is directly transmitted to the rotor or dewatering bin, the use of an electric technique of magnetic field weakening control to widen the high speed operation range has limitations because the current to weaken the magnetic field generates heat and deteriorates efficiency. Since the above direct drive type washing machine does not have any speed reduction mechanism, the motor must deal with a wide speed range for washing and rinsing modes with a low speed and a high torque and a dewatering mode with a high speed and a large output power and consequently it must be large in size.

When a variable magnetic flux electric rotary machine according to the present invention is used as the motor and the centers of the same polarity magnet poles of the sub-rotors of the motor are aligned in the washing or rinsing mode, the amount of effective flux from the permanent magnets facing the stator magnet poles is increased and a high torque is obtained. On the other hand, for operation at high speed such as the dewatering mode, by rotating the sub-rotors relatively in a way that the centers of the same polarity magnet poles are not aligned, the amount of effective flux from the permanent magnets facing the stator magnet poles is decreased, namely a magnetic field weakening effect is mechanically produced, thereby achieving constant output characteristics in a high revolution speed range.

### Eighth Embodiment

The eighth embodiment concerns an example of an electric rotary machine as proposed by the present invention to a generator in a wind power generation system.

In conventional wind power generation systems, a high torque is obtained at low speed but there is difficulty in high speed operation because of the narrow range of revolution speed variation. Various approaches to solving this problem have been attempted as follows. One approach is to widen the high speed operation range by an electric control technique of weakening the magnetic field. Also, in order to achieve a given level of output in a wide speed range, some power generation systems have adopted a generator which is provided with a gear mechanism and a pitch motor to cope with different wind conditions. Other systems have employed a device which switches the phase windings of the generator between the winding for low speed and that for high speed depending on the revolution speed of the main shaft. However, the electric control method of weakening the magnetic field to widen the high speed operation range has limitations because of heat generation and efficiency deterioration by the field weakening current. Also, a system which uses a device for switching phase windings depending on the revolution speed of the shaft has the following problem: the system has many lead wires from the generator and a winding switching controller is needed, thereby leading to a complicated structure.

In a wind power generation system which employs an electric rotary machine according to the first, second, third or fourth embodiment, in order for its generator to operate with high efficiency in a wide wind force range, the sub-rotors should be activated as follows. When the wind is weak, or the revolution speed is low, the centers of the same polarity magnet poles of the sub-rotors are aligned to increase the amount of effective flux from the permanent magnets facing the stator magnet poles to achieve high output characteristics. On the other hand, when the wind is strong, or the revolution speed is high, the sub-rotors are rotated relatively in a way that the centers of the same polarity magnet poles are not aligned, so the amount of effective flux from the permanent magnets facing the stator magnet poles is decreased, namely a magnetic field weakening effect is mechanically produced, thereby achieving constant output characteristics in a high speed range.

This embodiment offers an advantageous effect that the amount of effective flux for magnetic fields from permanent magnets can be varied mechanically. Particularly, in the shaft-mounted generator of a wind power generation system, the magnetic field can be weakened mechanically with ease and wide speed variation can be controlled effectively. The generator can be simple in structure and light in weight so that the tower structure can be simple.

### Ninth Embodiment

The ninth embodiment concerns an example of an electric rotary machine as proposed by the present invention to a motor-generator in a transport vehicle.

Permanent magnet synchronous motors are higher in efficiency than induction motors and are advantageous in terms of compactness and lightness. Also, a higher efficiency may lead to reductions in power consumption and CO₂ emissions. Since there is a strong demand for compact light drive motors for transport vehicles, the permanent magnet synchronous motor is a promising option. Furthermore, the whole main circuit, covering not only the motor but also the inverter, is anticipated to be light in weight. From the viewpoint of protection of the main converter, the motor should be designed so that the peak value of the back electromotive force of permanent magnets does not exceed at least the threshold for overvoltage protection of the DC intermediate circuit. However, if the motor is so designed, a larger inverter capacity is needed.

When a variable magnetic flux electric rotary machine according to the present invention is used as the motor and the centers of the same polarity magnet poles of the sub-rotors of the motor are aligned in a low-speed large-torque condition, the amount of effective flux from the permanent magnets facing the stator magnet poles is increased and a high torque is obtained. On the other hand, for operation at high speed, by rotating the sub-rotors relatively in a way that the centers of the same polarity magnet poles are not aligned, the amount of effective flux from the permanent magnets facing the stator magnet poles is decreased, namely a magnetic field weakening effect is mechanically produced, thereby achieving constant output characteristics in a high revolution speed range.

This embodiment offers an advantageous effect that the amount of effective flux for magnetic fields from permanent magnets can be varied mechanically. In addition, in the generator of a transport vehicle, the magnetic field can be weakened mechanically with ease and wide speed variation can be controlled effectively. Furthermore, since the effective flux is varied mechanically, the back electromotive force can be suppressed. As a result, the required inverter capacity is smaller. Consequently, the inverter cost can be reduced and the whole drive system can be more compact.

The aforementioned embodiments are illustrative and not restrictive.

The present invention provides an electric rotary machine which can be used in a mobile device with large load variation, vehicle, wind power generation system or transport vehicle and also provides a mobile device with large load variation, vehicle, wind power generation system or transport vehicle using the same.

What is claimed is:

1. An electric rotary machine comprising:
a stator having a winding;
a dual rotor which is rotatably disposed with a gap from the stator and divided axially along a shaft into a first rotor and a second rotor each having field magnets with different polarities arranged alternately in a rotation direction;
a mechanism for varying an axial position of the second rotor relative to the first rotor continuously; and
a non-magnetic member located between the first rotor and the second rotor.

2. An electric rotary machine comprising:
a stator having a winding;
a triple rotor which is rotatably disposed with a gap from the stator and divided axially along a shaft into a first rotor, a second rotor and a third rotor each having field magnets with different polarities arranged alternately in a rotation direction; and
a mechanism for varying axial positions of the second rotor and the third rotor relative to the first rotor continuously.

3. An electric rotary machine comprising:
a stator having a winding;
a rotor which is rotatably disposed with a gap from the stator and divided axially along a shaft into four or more sub-rotors each having field magnets with different polarities arranged alternately in a rotation direction; and
a control mechanism for controlling rotation of each rotor.

4. The electric rotary machine according to claim 1,
wherein the first rotor is fixed on the shaft;
wherein the second rotor can move axially while rotating through a spline structure of the shaft; and
wherein a support mechanism for supporting the second rotor and adjusting its axial position is provided.

5. The electric rotary machine according to claim 2,
wherein the first rotor of the triple rotor is fixed on the shaft;
wherein the second rotor and the third roller can move axially while rotating through a spline structure of the shaft;
wherein the third rotor is adjacent to the first rotor fixed on the shaft; and
wherein the electric rotary machine has a structure for the third rotor to rotate to an angle at which an attractive force and a repulsive force of magnets of the first rotor and the third rotor are balanced and a structure for the second rotor to rotate to an angle at which centers of magnets of the second rotor are aligned with centers of reverse-polarity magnets of the first rotor fixed on the shaft.

6. The electric rotary machine according to claim 5, wherein an axial length ratio of the first rotor, fixed on the shaft of the triple rotor, to the second rotor, rotatable relative to the first rotor, is approximately 1:1.

7. The electric rotary machine according to claim 5, wherein an axial length ratio of the first rotor, fixed on the shaft of the triple rotor, to the second rotor and the third rotor, rotatable relative to the first rotor, is approximately 1:1:1.

8. A vehicle comprising:
an internal combustion engine which drives wheels;
a battery which charges or discharges power;
a starter-alternator which is mechanically connected with a crankshaft of the internal combustion engine, driven by power supplied from the battery to drive the engine, and powered by the engine to generate power and supply the generated power to the battery;
a power converter which controls power supplied to the starter-alternator and power supplied from the starter-alternator; and
a controller which controls the power converter,
wherein the starter-alternator is an electric rotary machine according to claim 1.

9. A vehicle comprising:
an internal combustion engine which drives wheels;
a battery which charges or discharges power;
a motor-generator which is driven by power supplied from the battery to drive the wheels and receives a driving force from the wheels, generates power and supplies the generated power to the battery;
a power converter which controls power supplied to the motor-generator and power supplied from the motor-generator; and
a controller which controls the power converter,
wherein the motor-generator is an electric rotary machine according to claim 1.

10. A vehicle comprising:
a battery which charges or discharges power;
a motor-generator which is driven by power supplied from the battery to drive wheels and receives a driving force from the wheels, generates power and supplies the generated power to the battery;
a power converter which controls power supplied to the motor-generator and power supplied from the motor-generator; and
a controller which controls the power converter,
wherein the motor-generator is an electric rotary machine according to claim 1.

11. A mobile device comprising:
a battery which charges or discharges power; and
an electric rotary machine which is driven by power supplied from the battery to drive the mobile device,
wherein the mobile device has output characteristics of low-speed large torque and high-speed large-output; and
wherein the electric rotary machine is an electric rotary machine according to claim 1.

12. An air conditioner comprising:
a compressor which compresses a refrigerant circulating in a refrigerating cycle;
a motor which functions as a driving source for the compressor;
a drive circuit which drives the motor;
an indoor heat exchanger which exchanges heat with the refrigerant circulating in the refrigerating cycle in a room;
a heat exchanger which exchanges heat with the refrigerant circulating in the refrigerating cycle outdoors;
an expansion valve for the refrigerant circulating in the refrigerating cycle; and
a valve which changes a flow direction of the refrigerant circulating in the refrigerating cycle,
wherein the motor is an electric rotary machine according to claim 1.

13. A washing machine comprising:
a washing and dewatering tub rotatably journalled in an outer tub with a shaft as its center;
a rotor rotatably journalled on a bottom of the washing and dewatering tub with a shaft concentric with the shaft as its center;
a switching mechanism for connecting the shaft of the washing and dewatering tub to the shaft of the rotor or disconnecting the shaft of the washing and dewatering tub from the shaft of the rotor; and
a motor for rotating the rotor,
wherein the motor is an electric rotary machine according to claim 1.

14. A wind power generation system comprising:
a main shaft to which a blade is attached;
a generator connected with the main shaft;
an inverter electrically connected with the generator;
a controller for controlling the inverter;
means for controlling a pitch of the blade depending on a wind condition;
a brake for stopping rotation of the blade; and
an anemovane for detecting a wind condition,
wherein the generator is an electric rotary machine according to claim 1.

15. A hybrid transport vehicle requiring overhead wires and a rail track, comprising:
a plurality of types of energy supply means and drive means or
a hybrid transport vehicle designed to run on a predetermined rail track, comprising:
a plurality of energy supply means such as overhead wires, capacitor, fuel cell, engine or generator driven thereby; and
at least one driving means for running such as a motor or engine,
wherein the motor or generator is an electric rotary machine according to claim 1.
